(19) United States
(12) Patent Application Publication
(10) Pub. No.: US 2005/0185527 A1
(43) Pub. Date: Aug. 25, 2005

(54) APPARATUS AND METHOD FOR CONTROLLING AN OPTICAL DISC DRIVE TO FEED AND EJECT A DISC

(76) Inventors: Jui-Chiang Lin, Taipei City (TW); Tsung-Jung Kuo, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/710,304

(22) Filed: Jul. 1, 2004

(30) Foreign Application Priority Data
Feb. 25, 2004 (TW) 093104833

(51) Int. Cl. G11B 7/085

(52) U.S. Cl. 369/30.27; 720/601

(57) ABSTRACT

Apparatus and method for an optical disc drive to feed and eject a disc are provided. The optical disc drive includes a housing having an opening, a disc-driving device for feeding the disc into the housing or ejecting the disc to a pickup position through the opening, and a logic unit for controlling the disc-driving device to feed the disc into the housing when the disc has stayed at the pickup position over a predetermined time.

### BACKGROUND OF INVENTION

1. Field of the Invention

The present invention relates to an apparatus and related method for use in an optical disc drive, and more particularly, to an apparatus and related method of feeding or ejecting a disc used in an optical disc drive.

2. Description of the Prior Art

Optical media is a popular data storage means having high storage density, reliable data stability, and good portability. Compact discs (CDs) and digital versatile discs (DVDs) have all but replaced traditional competing storage devices such as magnetic floppy discs and audio and video tapes. While digital devices used to read and write optical media, such as CD-ROM drives and DVD players, are complicated and highly precise, technological innovation has made these devices reliable and practical.

However, a user using the conventional optical disc drive may forget to remove the ejected disc from the insertion slot on account of carelessness, resulting in the disc becoming dirty and stained due to a long time exposure in a dirty environment. Meanwhile, dust also drifts inside the optical disc drive when the insertion slot is open, resulting in damage to the optical disc drive. Therefore, an improvement of such conventional optical disc drive is required.

### SUMMARY OF INVENTION

It is therefore a primary objective of the claimed invention to provide an apparatus and related method of feeding or ejecting a disc used in an optical disc drive.

According to the claimed invention, a feed-and-eject disc device of an optical disc drive comprises a housing having an opening, a driving device for feeding a disc into the housing or ejecting the disc to a pickup position through the opening, and a logic unit for controlling the driving device to feed the disc into the housing when the time in which the disc has stayed at the pickup position reaches a predetermined time.

According to the claimed invention, a method for controlling an optical disc drive to feed and to eject a disc comprises the steps of when a disc is ejected to a pickup position, starting to count a time in which the disc stays at the pickup position, and when the time in which the disc has stayed at the pickup position reaches a predetermined time, feeding the disc into the optical disc drive.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 shows a disc being ejected to a pickup position from an optical disc drive.

FIG. 2 is a schematic diagram of the disc being fed within the optical disc drive according to the present invention.

FIG. 3 is a schematic diagram of the disc being ejected out of the optical disc drive according to the present invention.

FIG. 4 is a flowchart according to the present invention.

FIG. 5 is a schematic diagram of another embodiment of the disc being fed within the optical disc drive according to the present invention.

FIG. 6 is a schematic diagram of the disc being ejected out of the optical disc drive according to the present invention.

FIG. 7 shows another embodiment of a disc on a tray ejecting to a pickup position from an optical disc drive.

FIG. 8 is a schematic diagram of the tray positioned within the optical disc drive.

FIG. 9 is a schematic diagram of the tray being ejected out of the optical disc drive.

FIG. 10 is a flowchart of another embodiment according to the present invention.

### DETAILED DESCRIPTION

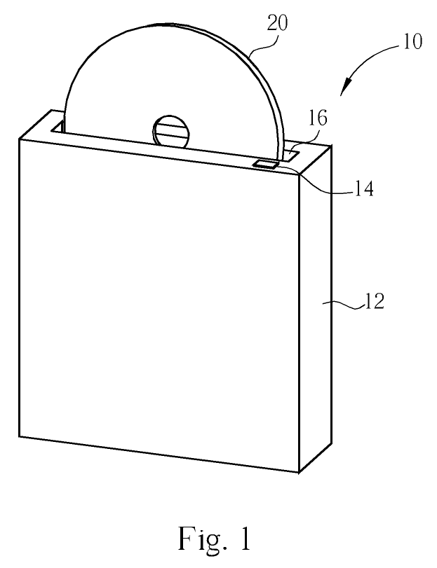

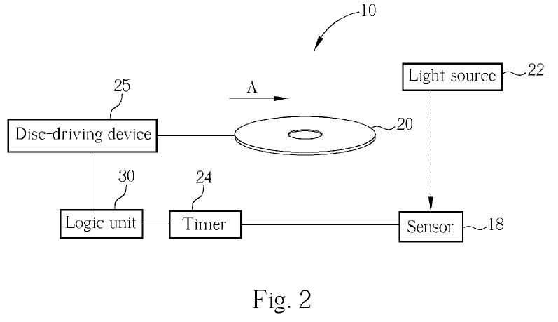

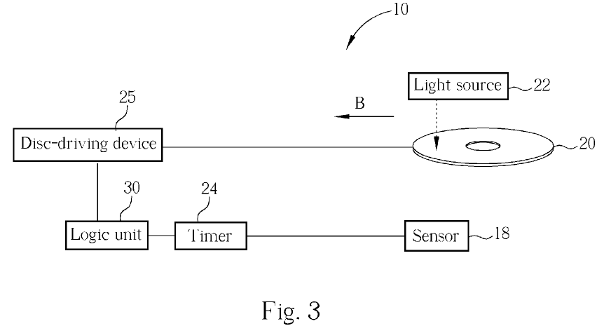

Please refer to FIGS. 1 to 3. FIG. 1 shows a disc 20 being ejected to a pickup position from an optical disc drive 10. FIG. 2 is a schematic diagram of the disc 20 being fed within the optical disc drive 10 according to the present invention. FIG. 3 is a schematic diagram of the disc 20 being ejected out of the optical disc drive 10 according to the present invention. The optical disc drive 10 comprises a housing 12, an insertion slot 16, and a control button 14. The user can press the control button 14 or utilize a software interface by means of a computer to control the disc-driving device 25 to feed or eject the disc 20 through the insertion slot 16. The optical disc drive 10 also comprises a sensor 18 and a light source 22. When the disc 20 is ejected to the pickup position, the disc 20 blocks the light emitted from the light source 22, thereby causing the sensor 18 to fail to sense the light. At this moment, the disc 20 is at the pickup position. While the disc 20 is at the pickup position, the logic unit 30 will drive the disc-driving device 25 to feed the disc 20 within the housing 12. In other words, when the disc 20 is removed, the sensor 18 senses the light again, so that the discdriving device 25 does not need to be activated. Conversely, when the disc 20 is not removed, the logic unit 30 drives the disc-driving device 25 to feed the disc 20 within the housing when the time in which the sensor 18 fails to sense the light reaches a predetermined time.

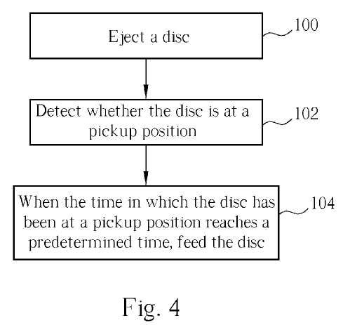

Please refer to FIG. 4, which is a flowchart of the present invention. It occurs as follows:

Step 100: Eject the disc 20 by pressing the control button 14 or utilizing a software interface by means of a computer to control the disc-driving device 25 to eject the disc 20 through the insertion slot 16, so that the disc is at a pickup position (i.e. the disc 20 is moved from the position shown in FIG. 2 along a direction of arrow A to the position shown in FIG. 3).

Step 102: Count the time in which the disc 20 stays at the pickup position. A timer 24 starts to count the time in which the sensor 18 fails to sense the light emitted from the light source 22, which results from the light being blocked by the disc 20.

Step 104: If the time in which the disc 20 has stayed at the pickup position reaches a predetermined time, the logic unit 30 drives the disc-driving device 25 to feed the disc 20 into the housing 12 (i.e. the disc 20 is moved from the position shown in FIG. 3 along a direction of arrow B to the position shown in FIG. 2).

Notice that, the timer 24 is activated to count time after the disc 20 is present within the housing 12. In other words, under the circumstance that the disc 20 is not present within the housing 12 in advance, the timer 24 does not count time even though the sensor 18 senses light from the light source 22.

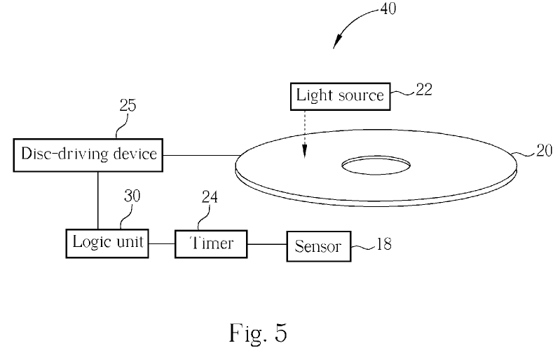

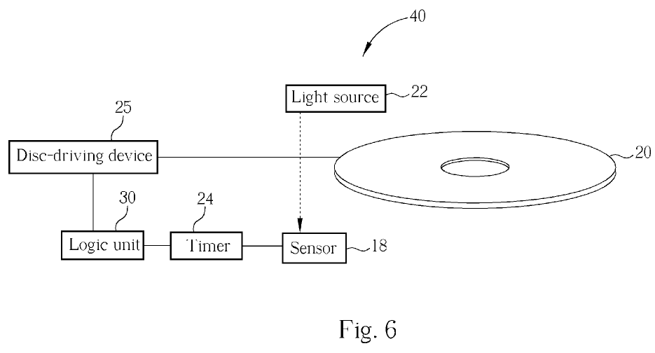

Another arrangement of the sensor 18 described as follows is possible. Please refer to FIG. 5 and FIG. 6. FIG. 5 is a schematic diagram of another embodiment of the disc 20 being fed within the optical disc drive 40 according to the present invention. FIG. 6 is a schematic diagram of the disc 20 being ejected out of the optical disc drive 40 according to the present invention. The optical disc drive 40 shown in FIGS. 5 and 6 is similar to the optical disc drive 10, except for the relative locations of the sensor 18, the light source 22, and the disc 20 fed within the housing 12. As shown in FIG. 5, the disc 20 in the housing 12 blocks the light emitted from the light source 22, such that the sensor 18 fails to sense the light, indicating the disc 20 is present within the housing 12. Conversely, as shown in FIG. 6, the disc 20 is ejected to a pickup position and the sensor 18 senses that the light is not blocked by the disc 20 again. The timer 24 starts to count time when the sensor 18 senses the light. If the time counted by the timer 24 reaches a predetermined time, the disc 20 is also fed.

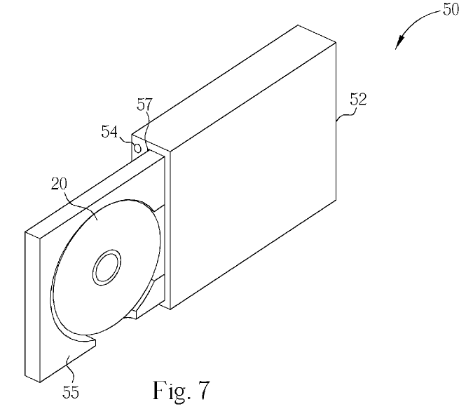

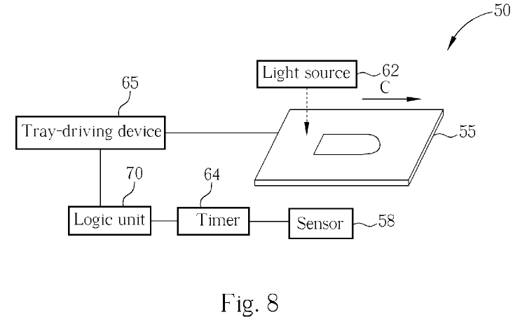

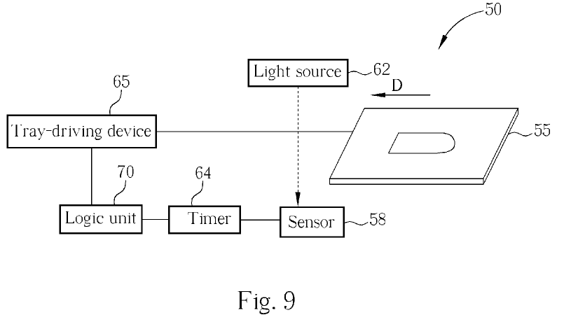

Please refer to FIGS. 7 to 9. FIG. 7 shows another embodiment of a disc 20 on a tray 55 ejecting to a pickup position from an optical disc drive 50. FIG. 8 is a schematic diagram of the tray 55 positioned within the optical disc drive 50. FIG. 9 is a schematic diagram of the tray 55 being ejected out of the optical disc drive 50. The optical disc drive 50 comprises a housing 52, an insertion slot 57, a tray 55 for supporting a disc 20, and a control button 54. The user can press the control button 54 or utilize a software interface by means of a computer to control the tray-driving device 25to feed or eject the tray 55 through the insertion slot 57. The optical disc drive 50 comprises a sensor 58 and a light source 62. When the sensor 58 fails to sense the light, indicating that the tray 55 is emerging out of the housing 52, the logic unit 70 drives the tray-driving device 65 to feed the tray 55 when the time in which the tray 55 has been out of the housing 52 reaches a predetermined time.

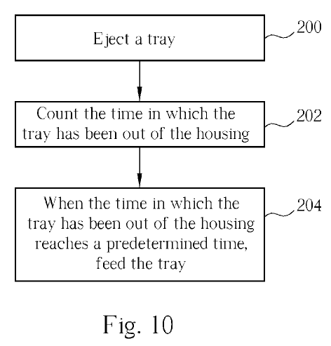

Please refer to FIG. 10 in conjunction with FIGS. 8 and 9. FIG. 10 is a flowchart of another embodiment according to the present invention. It occurs as follows:

Step 200: Eject the tray 55 by pressing the control button 54 or utilizing a software interface by means of a computer to control the tray-driving device 65 to eject the tray 55 (i.e. the tray 55 is moved from the position shown in FIG. 8 along a direction of arrow C to the position shown in FIG. 9).

Step 202: Count the time in which the tray 20 is out of the housing 52. A timer 64 starts to count time while the sensor 58 fails to sense the light emitted from the light source 62, resulting from the light being blocked by the tray 55.

Step 204: If the time in which the tray 55 has been out of the housing 52 reaches a predetermined time, the logic unit 70 drives the tray-driving device 65 to feed the tray 55 into the housing 52 (i.e. the tray 55 is moved from the position shown in FIG. 9 along a direction of arrow D to the position shown in FIG. 8).

Similarly, shifting the relative location of the sensor 58 and the light source 62 is allowed. In this case, the sensor 58 can sense the light from the light source 62 when the tray 55 is in the housing 52. Conversely, the sensor 58 fails to sense the light emitted from the light source 62 and the timer 54 starts to count time when the tray 55 is ejected out of the housing 52.

The optical disc drive 50 shown in FIG. 6 is a tray-in type optical disc drive, in which the sensor 58 is used for determining whether the tray 55 is emerging out of the housing 52. Alternatively, the sensor 58 of the optical disc drive 50 also can determine whether either the disc 20 or the tray 55 is ejected.

The above-mentioned predetermined time can be defined during the manufacture process of the optical disc drive or can be defined by the user at any time by means of a computer program.

The logic units 30, 70 can be a hardware circuit or computer code stored in a memory. The disc 20 can be a CD-R disc, a CD-RW disc, a DVD−R disc, a DVD+R disc, a DVD−RW disc, a DVD+RW disc, or a HD-DVD disc.

In contrast to prior art, the present invention optical disc drive can auto-feed the emerging disc or tray into the housing after a predetermined time has been exceeded, preventing the disc from being contaminated due to a long time exposure outside and preventing the optical disc drive from allowing dust to drift inside, thereby shortening its life.

Those skilled in the art will readily observe that numerous modifications and alterations of the device may be made while retaining the teachings of the invention. Accordingly, that above disclosure should be construed as limited only by the metes and bounds of the appended claims.

1. A feed-and-eject disc device of an optical disc drive, comprising:
a housing having an opening;
a driving device for feeding a disc into the housing or ejecting the disc to a pickup position through the opening; and
a logic unit for controlling the driving device to feed the disc into the housing when the time in which the disc has stayed at the pickup position reaches a predetermined time.

2. The feed-and-eject disc device of the optical disc drive of claim 1, further comprising a photosensor for detecting whether the disc is located at the pickup position.

3. The feed-and-eject disc device of the optical disc drive of claim 1, wherein the logic unit is a hardware circuit or software code stored in a memory.

4. The feed-and-eject disc device of the optical disc drive of claim 1, wherein the disc is a CD-R disc, a CD-RW disc, a DVD−R disc, a DVD+R disc, a DVD−RW disc, a DVD+RW disc, or a HD-DVD disc.

5. The feed-and-eject disc device of the optical disc drive of claim 1, wherein the driving device further comprises a tray for supporting the disc to feed the disc into the housing or to eject the disc to the pickup position.

6. A method for controlling an optical disc drive to feed and to eject a disc comprising:
when a disc is ejected to a pickup position, starting to count a time in which the disc stays at the pickup position; and
when the time in which the disc has stayed at the pickup position reaches a predetermined time, feeding the disc into the optical disc drive.

7. The method of claim 6, wherein the disc is a CD-R disc, a CD-RW disc, a DVD−R disc, a DVD+R disc, a DVD−RW disc, a DVD+RW disc, or a HD-DVD disc.

8. The method of claim 6, wherein the optical disc drive is used for driving a tray to eject to the pickup position.

9. An feed-and-eject tray device of an optical disc drive, comprising:
a housing having an opening;
a tray for supporting a disc;
a tray-driving device for feeding the tray into the housing or ejecting the tray to a pickup position; and
a logic unit for controlling the tray-driving device for feed the tray into the housing when the time in which the tray has stayed at a pickup position reaches a predetermined time.

10. The feed-and-eject tray device of the optical disc drive of claim 9, further comprising a photosensor for detecting whether the disc is at the pickup position.

11. The feed-and-eject tray device of the optical disc drive of claim 9, wherein the logic unit is a hardware circuit or software code stored in a memory.

12. The feed-and-eject tray device of the optical disc drive of claim 9, wherein the disc is a CD-R disc, a CD-RW disc, a DVD−R disc, a DVD+R disc, a DVD−RW disc, a DVD+RW disc, or a HD-DVD disc.

13. A method for controlling an optical disc drive to feed and to eject a tray comprising:
when a tray is ejected to a pickup position, starting to count a time in which the tray stays at the pickup position; and
when the time in which the tray has stayed at the pickup position reaches a predetermined time, feeding the tray into the optical disc drive.

14. The method of claim 13, wherein the disc is a CD-R disc, a CD-RW disc, a DVD−R disc, a DVD+R disc, a DVD−RW disc, a DVD+RW disc, or a HD-DVD disc.
